(19) United States
(12) Patent Application Publication
(10) Pub. No.: US 2020/0267476 A1
(43) Pub. Date: Aug. 20, 2020

(54) MICRO-SPEAKER

(71) Applicant: LUXSHARE-ICT CO., LTD., Taipei City (TW)

(72) Inventor: Jiin-Tarng Huang, Taipei City (TW)

(73) Assignee: LUXSHARE-ICT CO., LTD., Taipei City (TW)

(21) Appl. No.: 16/867,784

(22) Filed: May 6, 2020

(30) Foreign Application Priority Data
Oct. 22, 2019 (TW) 108138133

(51) Int. Cl. H04R 9/06; H04R 1/28; H04R 9/04

(52) U.S. Cl. CPC H04R 9/06; H04R 1/2834; H04R 1/2811; H04R 2209/041; H04R 2400/11; H04R 2307/207; H04R 9/04

(57) ABSTRACT

A micro-speaker includes an annular bracket, a diaphragm, a voice coil, a base, and two magnet members. The annular bracket includes a first hollow portion, two opposite first long side portions, and two first short side portions between the first long side portions. The first long side portions and the first short side portions are around the first hollow portion. The diaphragm is on a top side of the annular bracket and connected to the first long side portions and the first short side portions. The base is on a bottom side of the annular bracket and includes a magnetic convex portion. The voice coil is in the first hollow portion, between the diaphragm and the base, and around the magnetic convex portion. The magnet members are respectively between the first long side portions and the base. The voice coil and the magnetic convex portion are between the magnet members.

### CROSS-REFERENCE TO RELATED APPLICATION

This non-provisional application claims priority under 35 U.S.C. § 119(a) to patent application Ser. No. 10/813,8133 in Taiwan, R.O.C. on Oct. 22, 2019, the entire contents of which are hereby incorporated by reference.

### BACKGROUND

### Technical Field

The instant disclosure relates to a speaker, and more particular to a micro-speaker.

### Related Art

The speaker known to the inventor has a diaphragm, a voice coil, and a single magnet member. The voice coil is around the magnet member and is connected to the diaphragm. By the magnetic force of the magnet member, the voice coil is driven to have a reciprocating movement to drive the diaphragm to vibrate, thereby generating sounds. A micro-speaker known to the inventor may be applied to mobile devices, such as smart phones. The size of the micro-speaker is much smaller than that of the speaker. If the micro-speaker has a single magnet member, the micro-speaker fails to provide a sufficient sound pressure. In order to improve the sound pressure efficiency, most of the micro-speakers known to the inventor have three magnet members, including a magnet member around the voice coil and magnet members on two sides of the voice coil.

### SUMMARY

Among the micro-speakers configured with three magnet members, the magnetic force directions of any two adjacent magnet members are different, causing the difficulty in assembly of the micro-speakers. Moreover, as the assembly fixtures are used to resist the attraction or repulsion between the magnet members for guiding the components to complete the assembly, the abrasion of the fixtures occurs easily. Furthermore, the magnetization of the micro-speakers requires two magnetization procedures applied separately, making the manufacturing process of the micro-speakers be more complicated.

In view of this, an embodiment of the instant disclosure provides a micro-speaker to simplify the manufacturing process, to reduce costs, and to maintain good sound pressure efficiency.

In one embodiment, the micro-speaker comprises an annular bracket, a diaphragm, a voice coil, a base, and two magnet members. The annular bracket comprises a first hollow portion, two first long side portions being opposite to each other, and two first short side portions being opposite to each other. The two first short side portions are between the two first long side portions. The two first long side portions and the two first short side portions are around the first hollow portion. The diaphragm is on a top side of the annular bracket. The diaphragm is connected to the two first long side portions and the two first short side portions. The voice coil is in the first hollow portion. The base is on a bottom side of the annular bracket. The voice coil is between the diaphragm and the base. The base comprises a magnetic convex portion. The voice coil is around the magnetic convex portion. The two magnet members are respectively between the two first long side portions and the base. The voice coil and the magnetic convex portion are between the two magnet members.

In one embodiment, the base further comprises a bottom plate. The magnetic convex portion extends from the bottom plate to the voice coil.

In one embodiment, the two magnet members are on the base. The voice coil extends to a space between each of the magnet members and the magnetic convex portion.

In one embodiment, the micro-speaker further comprises two magnetic conductive sheets. The two magnetic conductive sheets are respectively between the two first long side portions and the two magnet members.

In one embodiment, each of the magnet members comprises a first magnet portion and a second magnet portion. The first magnet portions are close to the magnetic convex portion. The second magnet portions are away from the magnetic convex portion, as compared with the first magnet portions.

In one embodiment, the two magnetic conductive sheets are respectively between the two first long side portions and the two first magnet portions.

In one embodiment, each of the magnetic conductive sheets is extended with at least one ear portion. Each of the first long side portions comprises at least one ear slot. The ear portion matches with the corresponding ear slot.

In one embodiment, the ear portions of the two magnetic conductive sheets are between the two first long side portions and the two second magnet portions.

In one embodiment, each of the magnetic conductive sheets comprises two ear portions. The two ear portions of each of the magnetic conductive sheets are spaced from each other. Each of the first long side portions comprises two ear slots. The two ear portions of each of the magnetic conductive sheets match with the corresponding two ear slots.

In one embodiment, a length of the first magnet portion is greater than a length of the second magnet portion.

In one embodiment, the voice coil comprises a second hollow portion, two second long side portions being opposite to each other, and two second short side portions being opposite to each other. The two second short side portions are between the two second long side portions. The two second long side portions and the two second short side portions are around the second hollow portion.

In one embodiment, each of the second long side portions is between each of the first long side portions and the magnetic convex portion. Each of the second short side portions is between each of the first short side portions and the magnetic convex portion.

As above, according to one or some embodiments of the instant disclosure, by the configurations of the two magnet members and the magnetic convex portion coordinating with one another, good sound pressure efficiency can be maintained. Furthermore, because the two magnet members have the same magnetic force direction, the manufacturing process can be simplified, and the abrasion of the fixtures can be avoided, thereby reducing the overall production cost.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a micro-speaker according to an exemplary embodiment of the instant disclosure;

FIG. 2 illustrates an exploded view of the micro-speaker shown in FIG. 1;

FIG. 3 illustrates an exploded view of an annular bracket and two magnetic conductive sheets of the micro-speaker shown in FIG. 1, from another perspective;

FIG. 4 illustrates a cross-sectional view along line 4-4 of the micro-speaker shown in FIG. 1; and

FIG. 5 illustrates a schematic diagram of magnetic field lines of the micro-speaker shown in FIG. 4.

### DETAILED DESCRIPTION

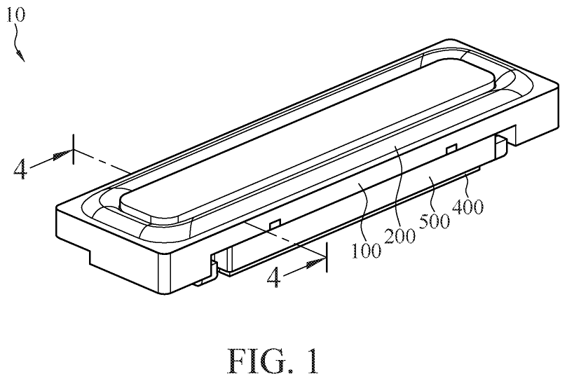

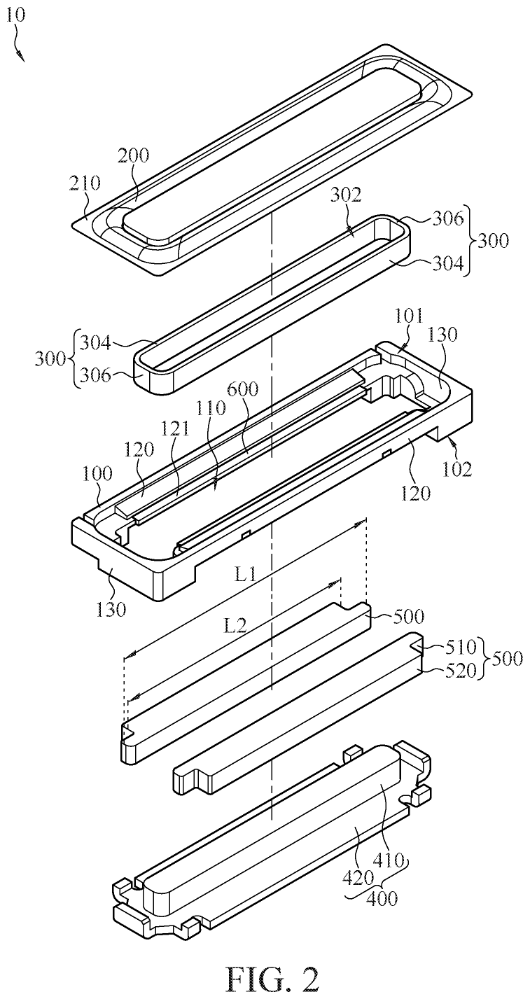

Please refer to FIGS. 1 and 2. FIG. 1 illustrates a perspective view of a micro-speaker 10 according to an exemplary embodiment of the instant disclosure. FIG. 2 illustrates an explode view of the micro-speaker 10 shown in FIG. 1. In this embodiment, the overall appearance of the micro-speaker 10 is flat and thin, but embodiments are not limited thereto. The micro-speaker 10 comprises an annular bracket 100, a diaphragm 200, a voice coil 300, a base 400, and two magnet members 500. As shown in FIG. 2, in this embodiment, the annular bracket 100 comprises a top side 101 and a bottom side 102 opposite to the top side 101. As shown in FIGS. 1 and 2, the diaphragm 200 is on the top side 101 of the annular bracket 100, and the base 400 is on the bottom side 102 of the annular bracket 100. The annular bracket 100 is around the voice coil 300, and the two magnet members 500 are between the base 400 and the annular bracket 100.

As shown in FIG. 2, in this embodiment, the annular bracket 100 comprises a hollow portion 110 (namely, the first hollow portion), two long side portions 120 (namely, the first long side portions) being opposite to each other, and two short side portions 130 (namely, the first short side portions) being opposite to each other. The two short side portions 130 are between the two long side portions 120. The two long side portions 120 and the two short side portions 130 are formed as a ring structure. The two long side portions 120 and the two short side portions 130 are surrounded to form the hollow portion 110. The diaphragm 200 is fixed on the top side 101 of the annular bracket 100, and the diaphragm 200 is connected to the two long side portions 120 and the two short side portions 130. In this embodiment, the diaphragm 200 is of a rectangular shape, and the diaphragm 200 is fixed on the top side 101 of the two long side portions 120 and the two short side portions 130 of the annular bracket 100 by gluing, but embodiments are not limited thereto.

In this embodiment, the voice coil 300 is movably received in the first hollow portion 110. The voice coil 300 is between the diaphragm 200 and the base 400. One end of the voice coil 300 is connected to the diaphragm 200. The voice coil 300 can have a reciprocating movement between the diaphragm 200 and the base 400 to drive the diaphragm 200 to vibrate, thereby generating sounds. The base 400 comprises a magnetic convex portion 410 and a bottom plate 420. The magnetic convex portion 410 is connected to the bottom plate 420, and the voice coil 300 is around the magnetic convex portion 410. The two magnet members 500 are disposed corresponding to the two long side portions 120 of the annular bracket 100. The two magnet members 500 are respectively between the two long side portions 120 and the base 400, and the voice coil 300 and the magnetic convex portion 410 are between the two magnet members 500. In this embodiment, the voice coil 300 is a rectangular ring structure corresponding to the two long side portions 120 and the two short side portions 130, but embodiments are not limited thereto.

The voice coil 300 further comprises a hollow portion 302 (namely, the second hollow portion), two long side portions 304 (namely, the second long side portions) being opposite to each other, and two short side portions 306 (namely, the second short side portions) being opposite to each other. The hollow portion 302 are surrounded by the two long side portions 304 and the two short side portions 306. Each of the long side portions 304 is between each of the long side portions 120 and the magnetic convex portion 410. Each of the short side portions 306 is between each of the short portions 130 and the magnetic convex portion 410. In some embodiments, the hollow portion 302 of the voice coil 300 corresponds to the hollow portion 110 of the annular bracket 100, and the size of the hollow portion 302 of the voice coil 300 is proportional to the size of the hollow portion 110 of the annular bracket 100. Therefore, the voice coil 300 can be received in the hollow portion 110 of the annular bracket 100. In some embodiments, the shape of the magnetic convex portion 410 corresponds to the shape of the hollow portion 302 of the voice coil 300, so that the magnetic convex portion 410 can be received in the hollow portion 302 of the voice coil 300.

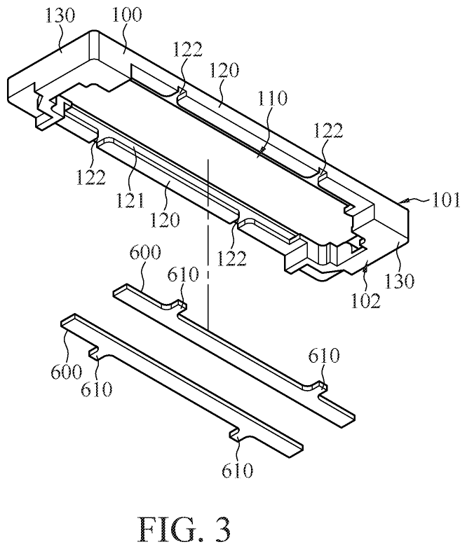

Please refer to FIG. 3. FIG. 3 illustrates an exploded view of the annular bracket 100 and two magnetic conductive sheets 600 of the micro-speaker 10 shown in FIG. 1, from another perspective. As shown in FIGS. 2 and 3, in this embodiment, the micro-speaker 10 further comprises the two magnetic conductive sheets 600. The two magnetic conductive sheets 600 are respectively between the two long side portions 120 and the two magnet members 500. Furthermore, each of the long side portions 120 further comprises an inner edge piece 121 and an ear slot 122. The two inner edge pieces 121 extend toward each other from the corresponding long side portions 120. Each of the magnetic conductive sheets 600 is between the inner edge piece 121 of the corresponding long side portion 120 and the corresponding magnet member 500. As shown in FIG. 3, in this embodiment, each of the magnetic conductive sheets 600 is extended with at least one ear portion 610. Each of the long side portions 120 further comprises an ear slot 122, and each of the ear slots 122 is in the bottom side 102 of the corresponding long side portion 120. Each of the magnetic conductive sheets 600 is in contact with the inner edge piece 121 of the corresponding long side portion 120. The ear portion 610 of each of the magnetic conductive sheets 600 matches with the ear slot 122 of the corresponding long side portion 120. Because of the configuration of the matching between the ear portions 610 and the ear slots 122, a better positioning effect for the magnetic conductive sheets 600 can be provided. In this embodiment, each of the magnetic conductive sheets 600 has two ear portions 610, and the two ear portions 610 of each of the magnetic conductive sheets 600 are spaced from each other. Conversely, each of the long side portions 120 has two ear slots 122, and the two ear portions 610 of each of the magnetic conductive sheets 600 match with the two ear slots 122 of the corresponding long side portion 120.

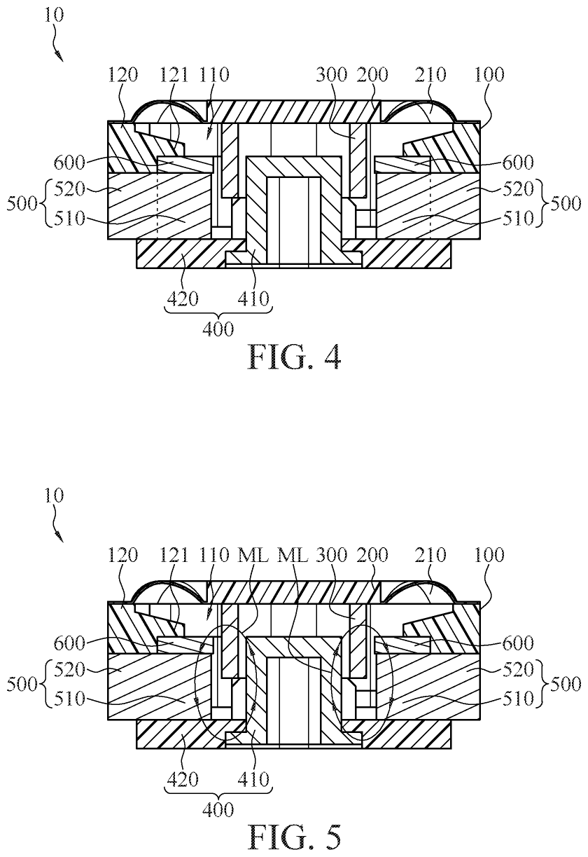

Please refer to FIG. 4. FIG. 4 illustrates a cross-sectional view along line 4-4 of the micro-speaker 10 shown in FIG. 1. As shown in FIGS. 2 and 4, in this embodiment, the two magnet members 500 are on the bottom plate 420, and at least one part of the voice coil 300 extends to a space between each of the magnet members 500 and the magnetic convex portion 410. Furthermore, each of the magnet members 500 comprises a first magnet portion 510 and a second magnet portion 520. The first magnet portions 510 are close to the magnetic convex portion 410, and the second magnet portions 520 are away from the magnetic convex portion 410, as compared with the first magnet portions 510; in other words, a distance between the first magnet portion 510 and the magnetic convex portion 410 is shorter than a distance between the second magnet portion 520 and the magnetic convex portion 410. In this embodiment, the two magnetic conductive sheets 600 are respectively between the two first long side portions 120 and the two first magnet portions 510. The ear portions 610 of the two magnetic conductive sheets 600 are between the two first long side portions 120 and the two second magnet portions 520. For example, each of the magnetic conductive sheets 600 is clamped between the inner edge piece 121 of the corresponding long side portion 120 and the corresponding first magnet portion 510. The ear portions 610 of each of the magnetic conductive sheets 600 is clamped between the corresponding long side portion 120 and the corresponding second magnet portion 520. That is, each of the magnetic conductive sheets 600 is in contact with the corresponding second magnet portion 520 only by the ear portions 610. Each of the magnetic conductive sheets 600 is in contact with the corresponding first magnet portion 510 only by the main structure thereof (that is, a part of the magnetic conductive sheet 600 excluding the ear portions 610) but not in contact with the second magnet portions 520.

As shown in FIG. 2, in this embodiment, the first magnet portion 510 has a length L1 along an extension direction parallel to the long side portions 120. The second magnet portion 520 has a length L2 along an the extension direction parallel to the long side portions 120. The length L1 of the first magnet portion 510 is greater than the length L2 of the second magnet portion 520.

As shown in FIGS. 2 and 4, in this embodiment, the magnetic convex portion 410 extends from the bottom plate 420 toward the diaphragm 200 and extends into the voice coil 300. The voice coil 300 is movably fitted over the magnetic convex portion 410, and at least one part of the voice coil 300 is between the magnetic convex portion 410 and the first magnet portion 510 of each of the magnet members 500. As shown in FIG. 4, in this embodiment, the cross-sectional areas of the magnetic convex portion 410 and the bottom plate 420 are formed as an inverted T-shape. As shown in FIGS. 2 and 4, in this embodiment, the diaphragm 200 further comprises a suspended edge 210. The suspended edge 210 is an annular structure. The suspended edge 210 is between the corresponding long side portions 120 and the voice coil 300 and is between the corresponding short side portions 130 and the voice coil 300.

Please refer to FIG. 5. FIG. 5 illustrates a schematic diagram of magnetic field lines ML of the micro-speaker 10 shown in FIG. 4. In this embodiment, the two magnet members 500 can generate magnetic field lines ML. The magnetic conductive sheets 600, the magnetic convex portion 410, and the bottom plate 420 are magnetic conductive. For example, the magnetic field lines ML generated by each of the magnet members 500 can be guided by the corresponding magnetic conductive sheets 600, the magnetic convex portion 410, and the bottom plate 420, to be concentrated between each of the magnet members 500 and the magnetic convex portion 410, so as to be concentrated on the voice coil 300 correspondingly. Therefore, the magnet members 500 can drive the voice coil 300 more efficiently, making the diaphragm 200 to vibrate more efficiently, thereby generating a sufficient sound pressure.

Furthermore, the magnetic conductive sheets 600 are arranged corresponding to the first magnet portions 510, and the magnetic conductive sheets 600 are close to the magnetic convex portion 410, as compared with the voice coil 300. That is, the main structures of the magnetic conductive sheets 600 excluding the ear portions 610 only cover the first magnet portions 510 but not cover the entire magnet members 500. Therefore, the magnetic field lines ML can be concentrated on the voice coil 300 more efficiently, thereby avoiding the overflow of the magnetic field lines ML through the second magnet portion 520.

As above, according to one or some embodiments of the instant disclosure, by the configurations of the two magnet members, the magnetic convex portion, the magnetic conductive sheets, and the bottom plate coordinating with one another, the magnetic field lines can be concentrated between the two magnet members and the magnetic convex portion. Furthermore, the magnetic conductive sheets are disposed to be relatively close to the voice coil, making the magnetic field lines be concentrated on the voice coil efficiently, thereby avoiding the overflow of the magnetic field lines. In this way, the micro-speaker can achieve a better sound pressure efficiency. Furthermore, because the two magnet members have the same magnetic force direction, one magnetization procedure is sufficient to magnetize the micro-speaker during the manufacturing process thereof. Accordingly, the manufacturing process can be simplified, and the abrasion of the fixtures can be avoided, thereby reducing the overall production cost. Moreover, in one embodiment, the voice coil and the annular bracket are rectangular, so the micro-speaker is also of a rectangular shape. Therefore, as compared with the speakers with a circular appearance as a whole generally having a circular voice coil and a circular bracket known to the inventor, the micro-speaker according to one or some embodiments of the instant disclosure can occupy less space in the electronic equipment to facilitate the installation of other electronic components in the electronic equipment. Hence, the micro-speaker according one or some embodiments of the instant disclosure is more suitable for the electronic equipment (such as laptops, mobile phones, etc.).

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A micro-speaker, comprising:
an annular bracket comprising a first hollow portion, two first long side portions being opposite to each other, and two first short side portions being opposite to each other, wherein the two first short side portions are between the two first long side portions, and the two first long side portions and the two first short side portions are around the first hollow portion;
a diaphragm on a top side of the annular bracket, wherein the diaphragm is connected to the two first long side portions and the two first short side portions;
a voice coil in the first hollow portion;
a base on a bottom side of the annular bracket, wherein the voice coil is between the diaphragm and the base, the base comprises a magnetic convex portion, and the voice coil is around the magnetic convex portion; and
two magnet members respectively between the two first long side portions and the base, wherein the voice coil and the magnetic convex portion are between the two magnet members.

2. The micro-speaker according to claim 1, wherein the base further comprises a bottom plate, and the magnetic convex portion extends from the bottom plate to the voice coil.

3. The micro-speaker according to claim 2, wherein the two magnet members are on the base, and the voice coil extends to a space between each of the magnet members and the magnetic convex portion.

4. The micro-speaker according to claim 1, further comprising two magnetic conductive sheets, wherein the two magnetic conductive sheets are respectively between the two first long side portions and the two magnet members.

5. The micro-speaker according to claim 4, wherein each of the magnet members comprises a first magnet portion and a second magnet portion, the first magnet portions are close to the magnetic convex portion, and the second magnet portions are away from the magnetic convex portion compared with the first magnet portions.

6. The micro-speaker according to claim 5, wherein the two magnetic conductive sheets are respectively between the two first long side portions and the two first magnet portions.

7. The micro-speaker according to claim 6, wherein each of the magnetic conductive sheets is extended with at least one ear portion, each of the first long side portions comprises at least one ear slot, and the ear portion matches with the corresponding ear slot.

8. The micro-speaker according to claim 7, wherein the ear portions of the two magnetic conductive sheets are between the two first long side portions and the two second magnet portions.

9. The micro-speaker according to claim 7, wherein each of the magnetic conductive sheets comprises two of the ear portions, the two ear portions of each of the magnetic conductive sheets are spaced from each other, each of the first long side portions comprises two of the ear slots, and the two ear portions of each of the magnetic conductive sheets match with the corresponding two ear slots.

10. The micro-speaker according to claim 5, wherein a length of the first magnet portion is greater than a length of the second magnet portion.

11. The micro-speaker according to claim 1, wherein the voice coil comprises a second hollow portion, two second long side portions being opposite to each other, and two second short side portions being opposite to each other, the two second short side portions are between the two second long side portions, and the two second long side portions and the two second short side portions are around the second hollow portion.

12. The micro-speaker according to claim 11, wherein each of the second long side portions is between each of the first long side portions and the magnetic convex portion, and each of the second short side portions is between each of the first short side portions and the magnetic convex portion.
